(19) United States
(12) Patent Application Publication
(10) Pub. No.: US 2014/0172960 A1
(43) Pub. Date: Jun. 19, 2014

(54) ELECTRONIC DEVICE AND METHOD FOR MANAGING TAGS OF VIRTUAL MACHINES

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); KUAN-CHIAO PENG, New Taipei (TW); TING-YU WEN, New Taipei (TW); YEN-HUNG LIN, New Taipei (TW)

(73) Assignee: HON HAI PRECISION INDUSTRY CO., LTD., New Taipei (TW)

(21) Appl. No.: 14/105,197

(22) Filed: Dec. 13, 2013

(30) Foreign Application Priority Data
Dec. 19, 2012 (TW) 101148288

(51) Int. Cl. H04L 29/06; G06F 17/30

(52) U.S. Cl. CPC H04L 67/42; G06F 17/30477
USPC 709/203

(57) ABSTRACT

A method for managing tags of virtual machines in a server involves presetting tags of the virtual machines. The preset tags include system tags and customized tags. The system tags and the customized tags carry out preset functions. The method further involves receiving a query request of a specified tag from a client computer, obtaining a specified virtual machine and one or more preset functions corresponding to the specified tag, and transmitting the specified virtual machine and the one or more preset functions corresponding to the specified tag to the client computer.

### BACKGROUND

1. Technical Field

Embodiments of the present disclosure relate to cloud computing technology, and particularly to an electronic device and method for managing tags of virtual machines.

2. Description of Related Art

Cloud computing services allow users to apply and create customized virtual machines (VMs) from a cloud service provider. Thus, the users do not need to buy expensive hardware (e.g. servers), and the virtual machines can perform functions of physical servers. However, user interfaces and services provided by different cloud service providers may be different.

When the number of the virtual machines is increased, it becomes hard to manage the virtual machines. The function of each virtual machine may be different, for example, some virtual machines are used as database, and some other virtual machines are used as test machines. In some cloud service systems, the virtual machines are classified by different tags, so that a user can query corresponding virtual machines using the tags.

However, the tags are preset by the cloud service provider, and the user cannot create tags having customized functions for the VMs. For example, a tag of “database” can merely query the database in the server, but cannot add storage spaces of the database which is a customized function defined by the user. Therefore, a more efficient method for managing tags of virtual machines is desired.

### BRIEF DESCRIPTION OF THE DRAWINGS

FIG. 1 is a schematic diagram of a server connected to a plurality of client computers.

FIG. 2 is a block diagram of one embodiment of a client computer including a VM tag management client system.

FIG. 3 is a block diagram of one embodiment of the server including a VM tag management server system.

FIG. 4 is a schematic block diagram of function modules of the VM tag management client system included in the client computer.

FIG. 5 is a schematic block diagram of function modules of the VM tag management server system included in the server.

FIG. 6 is a flowchart of one embodiment of a method for managing tags of virtual machines.

FIG. 7 is a schematic diagram of a process of querying data from a database of the server.

FIGS. 8 through 15 are schematic diagrams of operation interfaces of the VM tag management client system.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other storage medium.

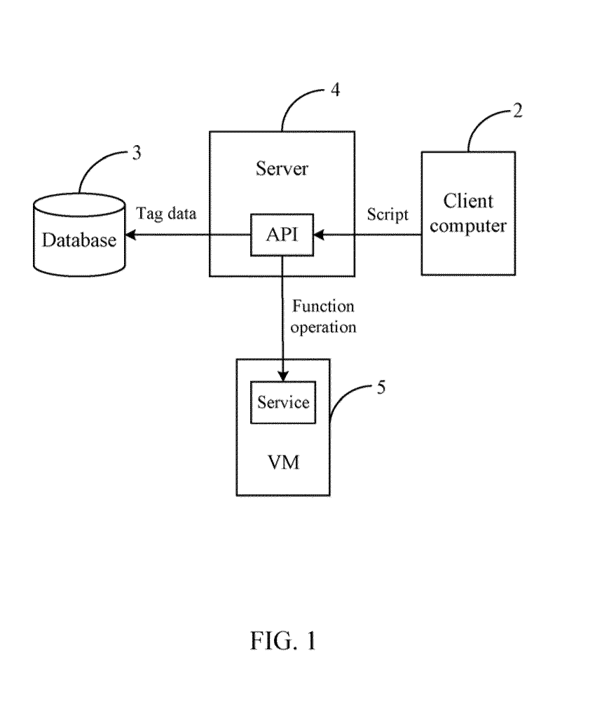

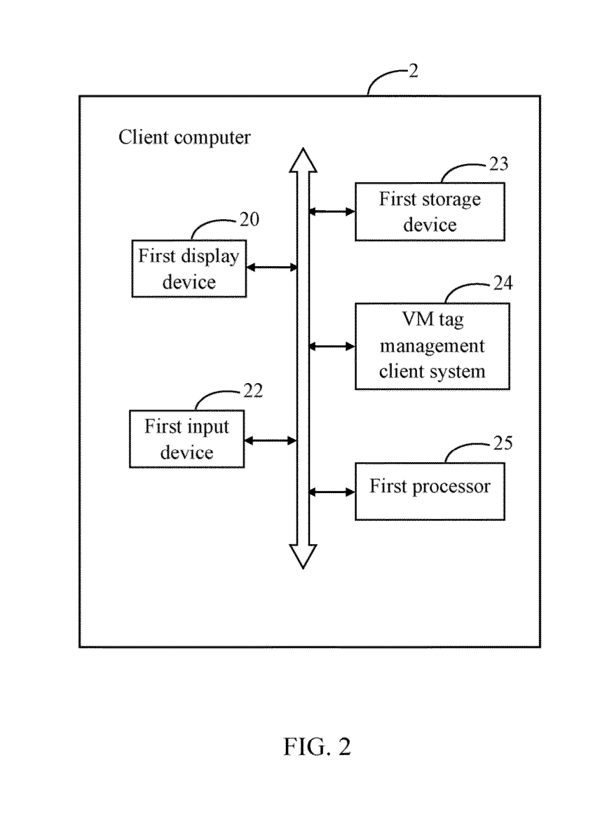

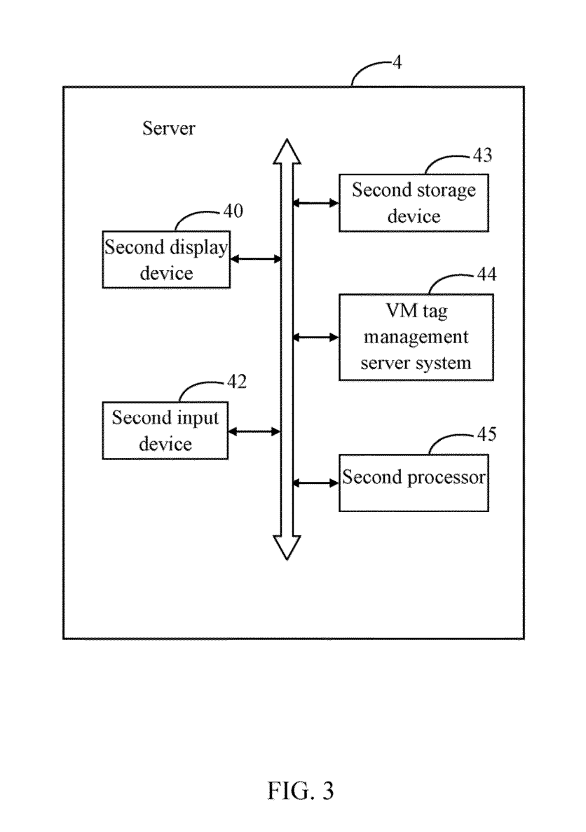

FIG. 1 is a schematic diagram of a server 4 connected to a plurality of client computers 2 (only one shown in FIG. 1 and hereinafter referred to as “the client computer 2). In one embodiment, the server 4 is connected to the client computers 2 through a network. The network may be an intranet, the Internet, or other suitable communication network, such as general packet radio service (GPRS), WIFI/wireless local area network (WIFI/WLAN), third generation/wideband code division multiple access (3G/WCDMA), or 3.5G/high-speed downlink packet access (3.5G/HSDPA). The server 4 is further connected to a database 3 through a data access technology, such as a JAVA database connectivity (JDBC) or an open database connectivity (ODBC). A plurality of virtual machines (VMs) 5 (only one VM is shown in FIG. 1) are installed in the server 4. The virtual machines 5 provide corresponding services to the client computers 2. In one embodiment, as shown in FIG. 2, a VM tag management client system 24 is installed in each of the client computers 2. FIG. 3 shows that a VM tag management server system 44 is installed in the server 4.

The database 3 stores tag information (e.g., a tag name) of the virtual machines 5. The tag information is set by the server 4. The client computer 2 may invoke corresponding services of the virtual machines 5 through an application programming interface (API) and execute preset functions corresponding to the tags of the virtual machines 5. For example, the client computer 2 executes a script document (JAVA SCRIPT) sent from the server 4. In one embodiment, a customized function is provided by one specified script document. For example, the customized function may be used to increase storage space of the virtual machines 5.

FIG. 2 is a block diagram of one embodiment of an client computer 2 including the VM tag management client system 24. In one embodiment, the client computer 2 further includes a first display device 20, a first input device 22, a first storage device 23, and a first processor 25. FIG. 2 illustrates only one example of the client computer 2 that may include more or fewer components than illustrated, or have a different configuration of the various components in other embodiments. The client computer 2 may be a desk-top computer, a mobile phone, a personal digital assistant (PDA) or other suitable electronic devices.

The first display device 20 displays the tag information and virtual machine information. The first input device 22 may be a mouse, a keyboard, a touch screen, or other suitable device for data input. The first storage device 23 may be a non-volatile computer storage chip that can be electrically erased and reprogrammed, such as a hard disk or a flash memory card.

In one embodiment, the VM tag management client system 24 is used to create associations between each VM tag and one or more preset functions, and execute the preset functions of a specified tag when the specified tag is queried by a user of the client computer 2. For example, one preset function is restarting one of the virtual machines 5. The VM tag management client system 24 can include computerized instructions in the form of one or more programs that are executed by the first processor 25 and stored in the first storage device 23 (or memory).

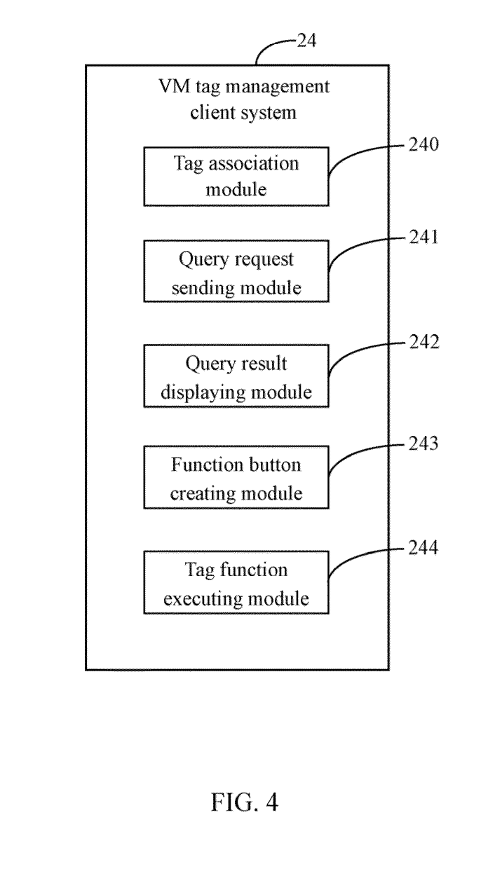

FIG. 4 is a block diagram of function modules of the VM tag management client system 24 included in the client computer 2. In one embodiment, the VM tag management client system 24 may include one or more modules, for example, a tag association module 240, a query request sending module 241, a query result displaying module 242, a function button creating module 243, and a tag function executing module 244. In general, the word “module”, as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include flash memory and hard disk drives.

FIG. 3 is a block diagram of one embodiment of the server 4 including the VM tag management server system 24. In one embodiment, the server 4 further includes a second display device 40, a second input device 42, a second storage device 43, and a second processor 45. FIG. 3 illustrates only one example of the server 4 that may include more or fewer components than illustrated, or have a different configuration of the various components in other embodiments. In one embodiment, the second display device 40 and the second input device 22 are input/output devices of the server 4.

In one embodiment, the VM tag management server system 44 is used to preset one or more functions associated with each VM tag, and transmit the preset functions of a specified tag to the client computer 2 when the specified tag is queried by a user of the client computer 2. The VM tag management server system 44 may include computerized instructions in the form of one or more programs that are executed by the second processor 45 and stored in the second storage device 43 (or memory).

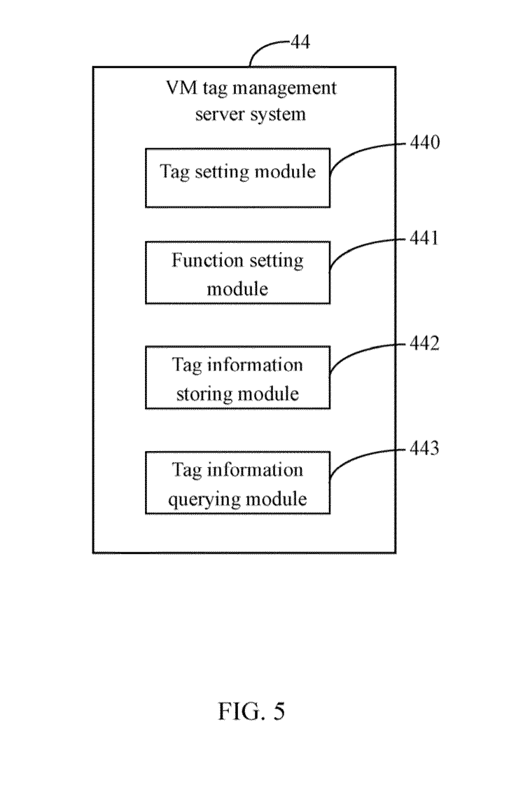

FIG. 5 is a block diagram of function modules of the VM tag management server system 44 included in the server 4. In one embodiment, the VM tag management server system 44 may include one or more modules, for example, a tag setting module 440, a function setting module 441, a tag information storing module 442, and a tag information querying module 443.

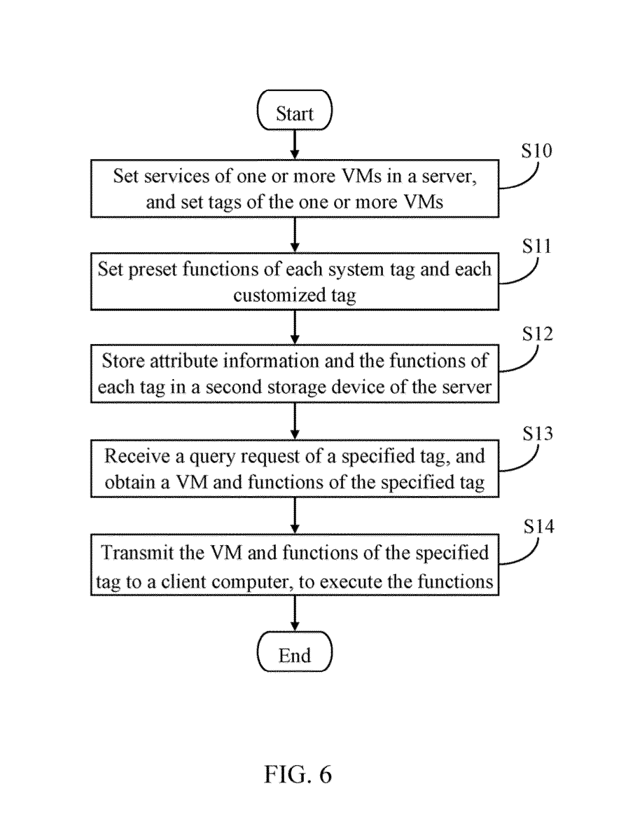

FIG. 6 is a flowchart of one embodiment of a method for managing tags of virtual machines. Depending on the embodiment, additional steps may be added, others removed, and the ordering of the steps may be changed.

In step S10, the tag setting module 440 sets services of one or more virtual machines 5 in the server 4, and sets tags of the one or more virtual machines 5. In one embodiment, the tags of the virtual machines 5 can be ordinary tags, system tags, and customized tags. The ordinary tag has a default function (e.g., the query function), which does not need to be set by the user. The system tag has one or more specified functions, which are selected from the preset functions of the virtual machines 5. For example, the system tag can be a function of restarting the virtual machines 5. The customized tag has one or more customized functions, which can be defined in script documents. For example, the customized tag has a customized function of adding storage space to the virtual machines 5.

In step S11, the function setting module 441 presets functions of each system tag and each customized tag.

If the tag is the system tag, the function setting module 441 sets one or more specified functions selected from the preset functions of the virtual machines 5 by a user of the client computer 2. The selected preset functions are determined as the preset functions of the system tag (hereinafter referred to as, “system preset functions”).

If the tag is the customized tag, the function setting module 441 sets one or more customized functions defined in script documents by the user of the client computer 2. The functions defined in the script documents are determined as the preset functions of the customized tag (hereinafter referred to as, “customized functions”). For example, the script document is JAVA SCRIPT code defining a customized function of adding storage space to the virtual machines 5.

In step S12, the tag information storing module 442 stores attribute information and the preset functions of each system tag and each customized tag in the second storage device 43 of the server 4. In one embodiment, the attribute information of the tag (e.g., the system tag) includes an identifier (ID) of the tag (tag ID), a name of the tag (tag name), and an ID of a virtual machine (VM ID) corresponding to the tag.

If the tag is the system tag, the tag information storing module 442 stores the preset functions of the system tag in the second storage device 43 of the server 4. If the tag is the customized tag, the tag information storing module 442 stores the script documents corresponding to the customized tag in the second storage device 43 of the server 4, and further stores a storage path of each script document in the database 3.

In step S13, when the query request sending module 241 of the client computer 2 sends a query request of a specified tag to the server 4, the tag information querying module 443 of the server 4 receives the query request of the specified tag from the client computer 2, and obtains a virtual machine 5 and one or more preset functions corresponding to the specified tag.

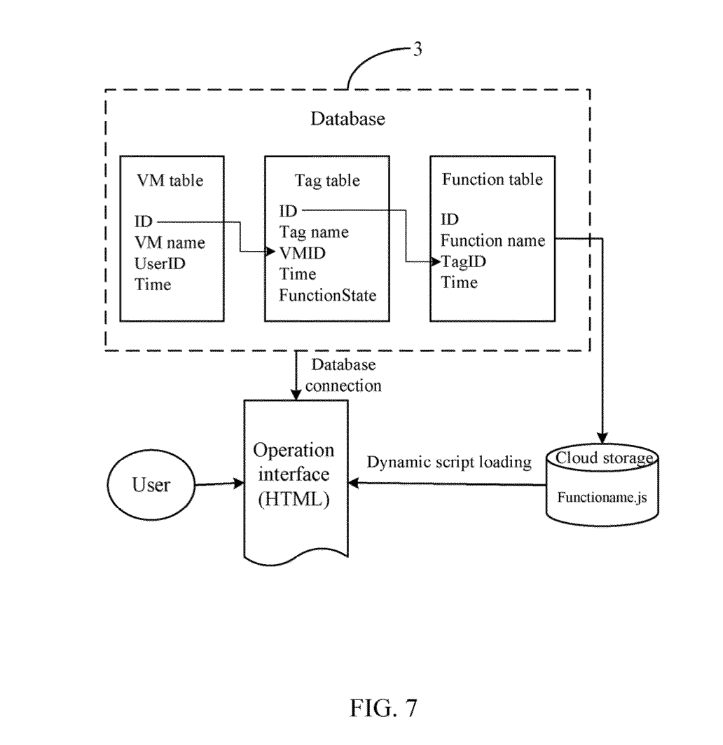

For example, as shown in FIG. 7, a virtual machine table (VM table), a tag table, and a function table are stored in the database 3. The tag information querying module 443 obtains the virtual machine corresponding to the specified tag from the VM table according to the ID of the specified tag, and further obtains the one or more preset functions corresponding to the specified tag from the function table according to the ID of the specified tag (VM ID→Tag ID→Functions).

Before the client computer 2 sends the query request, an association between each tag (e.g., the customized tag) and one or more corresponding functions are preset by the tag association module 240. For example, tag 1 is associated with function 1, tag 2 is associated with function 2, and tag 3 is associated with function 3.

In step S14, the tag information querying module 443 transmits the corresponding virtual machine 5 and one or more preset functions corresponding to the specified tag to the client computer 2. The query result displaying module 242 displays the virtual machine 5 corresponding to the specified tag on the first display device 20.

Then, the function button creating module 243 creates one or more function buttons according to the one or more preset functions corresponding to the specified tag, and displays the created function button/s on the first display device 20 of the client computer 2. When one of the function buttons is selected by the user, the tag function executing module 244 executes the corresponding function of the specified tag (e.g., invoke the corresponding function of the selected function button). In one embodiment, the function button can be a Checkbox button.

If the specified tag is the system tag, the tag function executing module 244 sends a first service request to a first virtual machine 5 corresponding to the specified tag, and invokes a first service in the first virtual machine 5 to execute a specified function selected from the preset functions of the specified tag.

If the specified tag is the customized tag, the tag function executing module 244 sends a second service request to a second virtual machine 5 corresponding to the specified tag, and invokes a second service in the second virtual machine 5 to execute a specified script document corresponding to the specified tag.

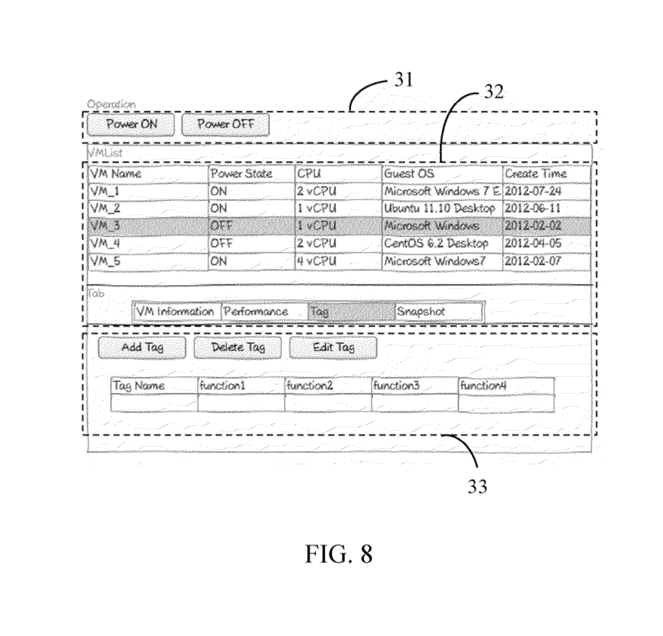

An example of managing the tags of the virtual machines 5 is described in FIGS. 8 through 15. A user operation interface is shown in FIG. 8. A top part of the user operation interface is defined as a system operation area 31. For example, a power on button and a power off button is displayed in the system operation area 31. The function buttons created by the function button creating module 243 are also displayed in the system operation area 31.

A middle part of the user operation interface is defined as a virtual machine list 32, which can include a VM name, a power state, and attribute information of a central processing unit (CPU) and operating system (OS). The virtual machines 5 are listed in the virtual machine list 32 using a Tab control button. For example, as shown in FIG. 8, the virtual machines 5 are listed according to VM information, VM performance (e.g., CPU utilization ratio), and the VM tags. The Tab control buttons also include a VM snapshot button, which is used to store a backup of the VM information or other suitable data.

A bottom part of the user operation interface is defined as a tag list 33 of the virtual machines 5. As shown in FIG. 8, if the user selects the “Tag” button of a virtual machine “VM_{—}3,” an “Add Tag” button, a “Delete Tag” button, and an “Edit Tag” button appear in the tag list 33. For example, the “Add Tag” button is used to add a new VM tag to the virtual machine VM_{—}3, the “Delete Tag” button is used to delete a VM tag from the virtual machine VM_{—}3, and the “Edit Tag” button is used to edit a current VM tag (e.g., updating the tag name) of the virtual machine VM_{—}3.

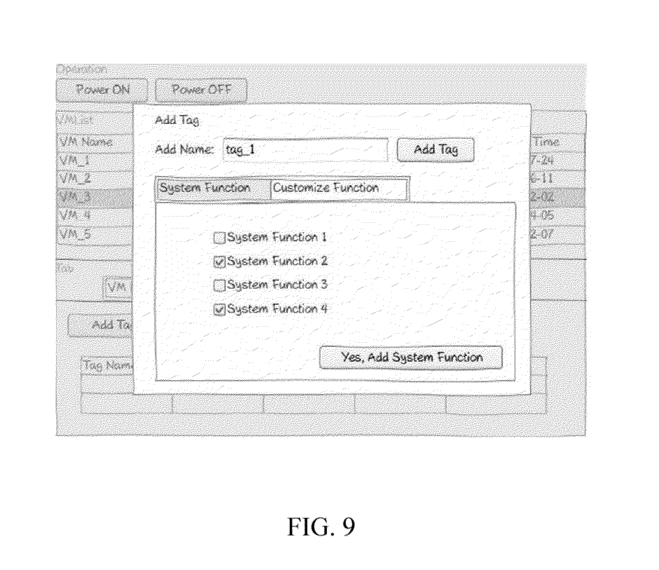

When the “Add Tag” button is selected, an operation interface of adding a new VM tag is shown in FIG. 9. When a tag name “tag_{—}1” is inputted, and the user clicks the “Add Tag” button, an ordinary tag with the name “tag_{—}1” is created for querying purposes. When the “System Function” button is selected by the user, a system tag is created. The user can select one or more functions for the created system tag from all the preset functions provided by the system tag. For example, as shown in FIG. 9, the system tag includes four preset functions. When the user selects a second preset function (System Function2) and a fourth preset function (System Function4), a system tag “tag_{—}1” having the second and the fourth preset functions is created.

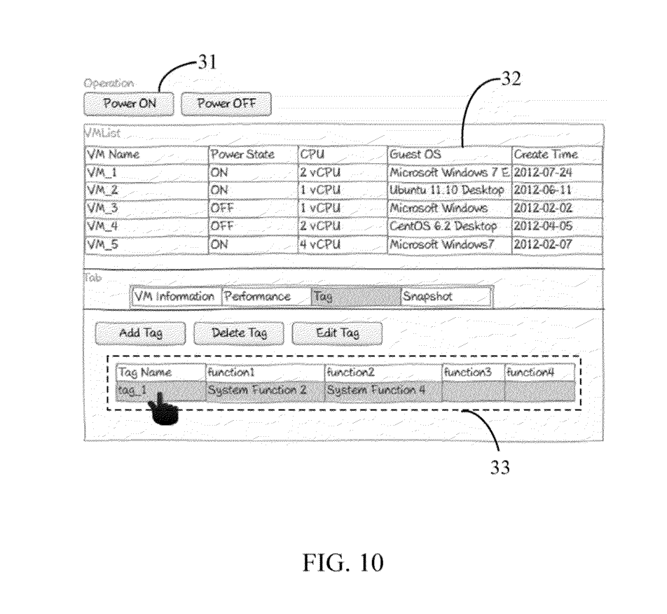

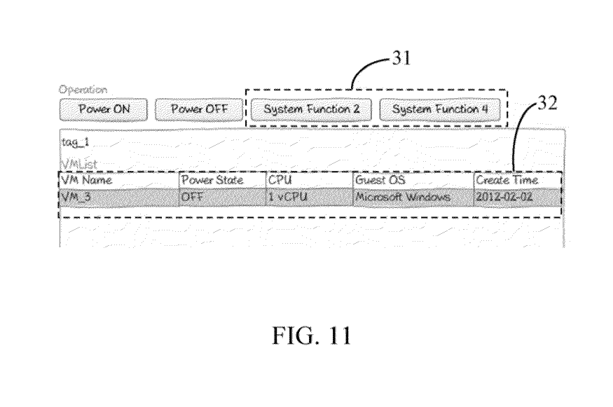

When the system tag “tag_{—}1” is created, an updated operation interface is shown in FIG. 10. The new system tag “tag_{—}1” and the corresponding preset functions are added in the tag list 33. When the system tag “tag_{—}1” is selected, the corresponding virtual machine “VM_{—}3” of the system tag “tag_{—}1” is displayed in the virtual machine list 32, and the corresponding preset functions of the system tag “tag_{—}1” are displayed in the system operation area 31 (as shown in FIG. 11). As shown in FIG. 11, two function buttons corresponding to the two selected preset functions of FIG. 9 are displayed in the system operation area 31, and the VM name “VM_{—}3” corresponding to the system tag “tag_{—}1” is displayed in the virtual machine list 32.

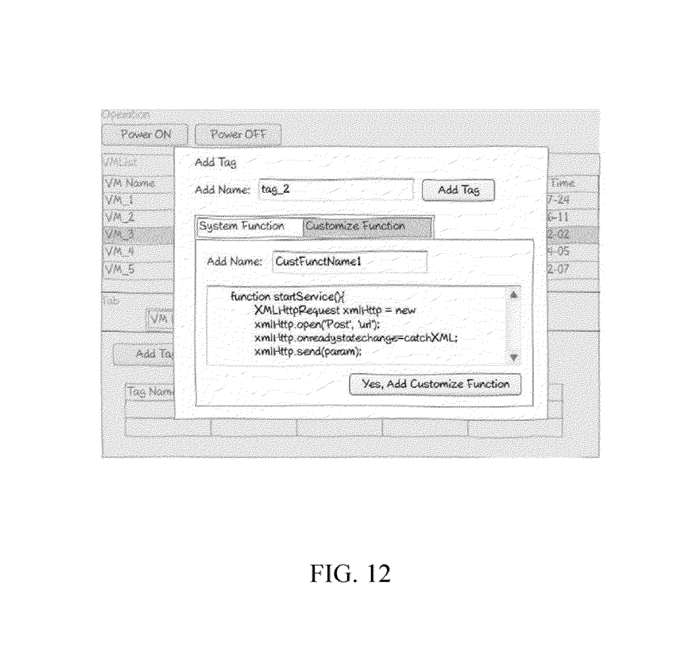

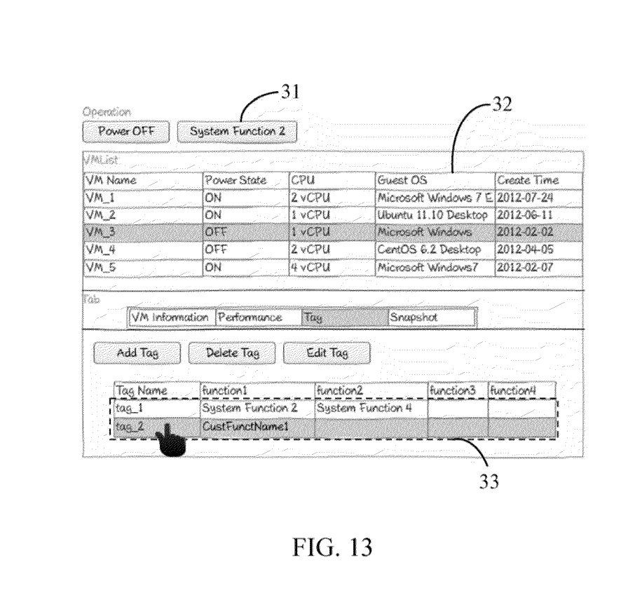

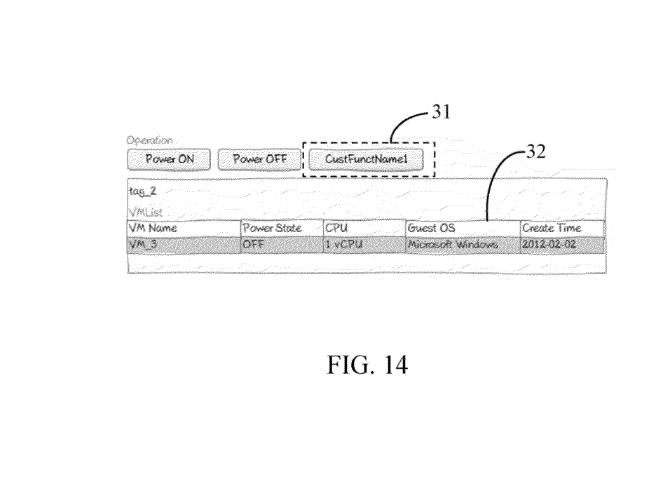

When a customized tag needs to be created, the “Customize Function” button is selected by the user in FIG. 12, and a tag name “tag_{—}2” and a function name “CustFunctName1” are inputted. After a script document is added, the customized tag “tag_{—}2” is created (as shown in FIG. 13). For example, the script document can be defined as “<script src=“CustFunctName1.js” type=“text/javascript”/>”. When the customized tag “tag_{—}2” is selected in FIG. 13, the script document corresponding to the customized tag “tag_{—}2” is invoked, and a customized function button “CustFunctName1” corresponding to the customized tag “tag_{—}2” is displayed in the system operation area 31 (as shown in FIG. 14). An onclick event of the customized function button can be defined as “javascript:StartService( )”. When the onclick event is triggered, the service of the virtual machine corresponding to the customized function button is invoked according to an asynchronous Java script and XML (AJAX) method.

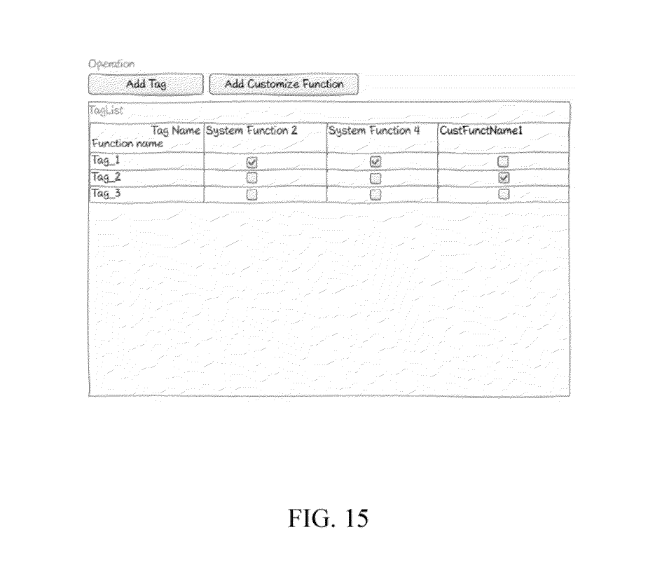

An association between each tag and the corresponding preset functions can be preset though a user operation interface as shown in FIG. 15. For example, the first tag “Tag_{—}1” is associated with the second system function “System Function2” and the fourth system function “System Function4,” and the second tag “Tag_{—}2” is associated with the customized function “CustFunctName1.”

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for managing tags of virtual machines in a server, the method comprising:
receiving preset tags of the virtual machines in the server, the preset tags comprising system tags and customized tags;
receiving preset functions of each of the system tags and each of the customized tags;
storing attribute information and the preset functions of each of the system tags and each of the customized tags in a storage device of the server;
receiving a query request of a specified tag from a client computer, and obtaining a specified virtual machine and one or more preset functions corresponding to the specified tag; and
transmitting the specified virtual machine and the one or more preset functions corresponding to the specified tag to the client computer.

2. The method according to claim 1, wherein the preset functions of each of the system tags are determined by selecting one or more specified functions from default functions of the virtual machines.

3. The method according to claim 1, wherein the preset functions of each of the customized tags are determined by specified functions in one or more preset script documents of the customized tags.

4. The method according to claim 1, wherein the attribute information of each of the system tags and each of the customized tags comprise a tag identifier (ID), a tag name, and a virtual machine ID corresponding to each of the system tags and each of the customized tags.

5. A method for managing tags of virtual machines using a client computer, the method comprising:
sending a query request of a specified tag to a server, the specified tag comprising a system tag and a customized tag;
receiving a specified virtual machine and one or more preset functions corresponding to the specified tag from the server, and displaying the specified virtual machine on a display device of the client computer;
creating one or more function buttons according to the one or more preset functions corresponding to the specified tag, and displaying the created one or more function buttons on the display device of the client computer; and
executing a corresponding function of a selected function button when one of the function buttons is selected.

6. The method according to claim 5, further comprising: creating an association between the specified tag and one or more preset functions corresponding to the specified tag.

7. The method according to claim 5, wherein the preset functions of the system tag are determined by selecting one or more specified functions from default functions of the virtual machines.

8. The method according to claim 7, further comprising:
sending a first service request to a first virtual machine corresponding to the specified tag when the specified tag is the system tag; and
invoking a first service in the first virtual machine to execute a specified function selected from the preset functions of the specified tag.

9. The method according to claim 5, wherein the preset functions of the customized tag are determined by specified functions in one or more preset script documents of the customized tag.

10. The method according to claim 9, further comprising:
sending a second service request to a second virtual machine corresponding to the specified tag when the specified tag is the customized tag; and
invoking a second service in the second virtual machine to execute a specified script document corresponding to the specified tag.

11. A server, comprising:
a processor;
a storage device storing a plurality of instructions and a plurality of virtual machines, which when executed by the processor, causes the processor to:
receive preset tags of the virtual machines, the preset tags comprising system tags and customized tags;
receive preset functions of each of the system tags and each of the customized tags;
store attribute information and the preset functions of each of the system tags and each of the customized tags in a storage device of the server;
receive a query request of a specified tag from a client computer, and obtain a specified virtual machine and one or more preset functions corresponding to the specified tag; and
transmit the specified virtual machine and the one or more preset functions corresponding to the specified tag to the client computer.

12. The server according to claim 11, wherein the preset functions of each of the system tags are determined by selecting one or more specified functions from default functions of the virtual machines.

13. The server according to claim 11, wherein the preset functions of each of the customized tags are determined by specified functions in one or more preset script documents of the customized tags.

14. The server according to claim 11, wherein the attribute information of each of the system tags and each of the customized tags comprise a tag identifier (ID), a tag name, and a virtual machine ID corresponding to each of the system tags and each of the customized tags.

15. The server according to claim 11, wherein the plurality of instructions further comprise: creating an association between the specified tag and one or more preset functions corresponding to the specified tag by the client computer.

16. The server according to claim 11, wherein the plurality of instructions further comprise:
sending a first service request to a first virtual machine corresponding to the specified tag when the specified tag is the system tag; and
invoking a first service in the first virtual machine to execute a specified function selected from the preset functions of the specified tag.

17. The server according to claim 11, wherein the plurality of instructions further comprising:
sending a second service request to a second virtual machine corresponding to the specified tag when the specified tag is the customized tag; and
invoking a second service in the second virtual machine to execute a specified script document corresponding to the specified tag.
